(19) United States
(12) Patent Application Publication
(10) Pub. No.: US 2025/0036479 A1
(43) Pub. Date: Jan. 30, 2025

(54) SYSTEM AND METHOD FOR TRACKING AND MANAGING STATE OF PROVISIONED WORKSPACES AND WORKLOADS

(71) Applicant: JPMorgan Chase Bank, N.A., New York, NY (US)

(72) Inventors: Neelamuhilvannan MAYAVANNAN, West Lothian (GB); Eyal LANTZMAN, Cambridge (GB); Jaroslaw PODGAJNY, Bromley (GB); Ramesh R THUMMA, Florham Park, NJ (US)

(73) Assignee: JPMorgan Chase Bank, N.A., New York, NY (US)

(21) Appl. No.: 18/785,541

(22) Filed: Jul. 26, 2024

Related U.S. Application Data
(60) Provisional application No. 63/529,546, filed on Jul. 28, 2023.

(51) Int. Cl. G06F 9/50; H04L 41/0806

(52) U.S. Cl. CPC G06F 9/5072; G06F 9/505; H04L 41/0806

(57) ABSTRACT

Various methods and processes, apparatuses or systems, and media for managing a state of a provisioned workspace with connectivity to a data resource in a regulated computing environment by utilizing one or more processors along with allocated memory are disclosed. The processor receives a request to provision a workspace in the regulated computing environment; determines an account capacity usage across a plurality of cloud computing environments; provisions the workspace in the regulated computing environment on a condition that a forecasted account capacity usage does not exceed a threshold capacity usage; establishes a connection with a computing resource external to the server system; and saves a state of the workspace using the computing resource external to the server system.

### CROSS-REFERENCE TO RELATED APPLICATIONS

This application claims the benefit of priority from U.S. Provisional Patent Application No. 63/529,546, filed Jul. 28, 2023, which is herein incorporated by reference in its entirety.

### TECHNICAL FIELD

This disclosure generally relates to data processing, and, more particularly, to methods and apparatuses for implementing a platform, language, cloud, and database agnostic workspace management module configured to manage workspaces and workloads at a cross cloud level, move entire workloads and re-provision connections just-in-time through existing deployment control planes, and seamlessly manage connectivity to other vendor products and data resources for Machine Learning Development Life Cycle (MDLC) purposes.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Distributed cloud environments appears to be becoming ubiquitous. Such distributed cloud environments may be dynamically scalable and may offer on-demand access to large amounts of computing resources. As such, many enterprise users may rely on cloud computing for work, data access, productivity tools or the like. The distributed cloud environment may also be an ideal platform for Artificial Intelligence and Machine Learning (AI/ML) which may require large amounts of processing power.

However, conventional approaches/tools fail to provide any capabilities to create a bounded environment (termed as a workspace) where users may perform AI/ML related activities including experimentation (data and model), freely while controls are maintained at the boundary.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic workspace management module configured to manage workspaces and workloads at a cross cloud level, move entire workloads and re-provision connections just-in-time through existing deployment control planes, and seamlessly manage connectivity to other vendor products and data resources for MDLC purposes, but the disclosure is not limited thereto.

In some embodiments, the workspace management module as disclosed herein may be utilized to create a bounded environment (termed as a workspace) where users may perform AI/ML related activities including experimentation (data and model), freely while controls are maintained at the boundary. As part of the platform capability, the workspace management module may be configured to save the state of a workspace where the users perform various AI/ML activities and store the state of the workspace associated with a model development for reproducibility and authoritative model building pipelines and as evidence for Model governance purposes, but the disclosure is not limited thereto.

In some embodiments, as part of the state storage, the workspace management module may be configured to capture the connectivity required to data products and data stores (data resources) to the workspace and vendor products and model frameworks while ensuring segregation and maintaining access control. Moreover, the workspace management module may be configured to reproduce these connections when the workspace migrates and provide least privilege orchestration to enable these connectivity only at time of workload launch and shutdowns after workload finishes and the membership of users to the workspaces, but the disclosure is not limited thereto.

In some embodiments, the workspace management module may be configured to store the state of workspaces to support the capability to migrate the workspaces and scale them for the workloads between cloud accounts due to limits and shared capacity usage in an automated manner.

In some embodiments, the workspace management module may be configured to hibernate a workspace during non-usage period and restart the workloads automatically during working periods.

In some embodiments, a method for managing a state of a provisioned workspace with connectivity to a data resource in a regulated computing environment by utilizing one or more processors along with allocated memory is disclosed. The method may include: receiving a request to provision a workspace in the regulated computing environment; determining an account capacity usage across a plurality of cloud computing environments; provisioning the workspace in the regulated computing environment on a condition that a forecasted account capacity usage does not exceed a threshold capacity usage; establishing a connection with a computing resource external to the server system; and saving a state of the workspace using the computing resource external to the server system.

In some embodiments, the method may further include: requesting a provisioned infrastructure status from an infrastructure configuration data store.

In some embodiments, the method may further include: updating a usage model of the infrastructure configuration data store according to a machine learning model based on telemetry data received from the cloud computing environments.

In some embodiments, the telemetry data may be aggregated according to rules received from an aggregation rule data store.

In some embodiments, the aggregated telemetry data may include at least one of a source identifier and context information.

In some embodiments, the method may further include: requesting an account capacity limit from a service limit subsystem; and adjusting the account capacity limit based on the forecasted account capacity usage.

In some embodiments, the method may further include: updating a usage model of the service limit subsystem according to a machine learning model.

In some embodiments, the method may further include: selecting a candidate account from a plurality of accounts, wherein the candidate account has a corresponding forecasted account capacity usage that does not exceed a threshold capacity usage for the candidate account.

In some embodiments, the method may further include: provisioning an account in the regulated computing environment on a condition that the forecasted account capacity usage exceeds the threshold capacity usage.

In some embodiments, a system for managing a state of a provisioned workspace with connectivity to a data resource in a regulated computing environment is disclosed. The system may include: a processor; and a memory operatively connected to the processor via a communication interface, the memory storing computer readable instructions, when executed, may cause the processor to: receive a request to provision a workspace in the regulated computing environment; determine an account capacity usage across a plurality of cloud computing environments; provision the workspace in the regulated computing environment on a condition that a forecasted account capacity usage does not exceed a threshold capacity usage; establish a connection with a computing resource external to the server system; and save a state of the workspace using the computing resource external to the server system.

In some embodiments, the processor may be further configured to: request a provisioned infrastructure status from an infrastructure configuration data store.

In some embodiments, the processor may be further configured to: update a usage model of the infrastructure configuration data store according to a machine learning model based on telemetry data received from the cloud computing environments.

In some embodiments, the processor may be further configured to: request an account capacity limit from a service limit subsystem; and adjust the account capacity limit based on the forecasted account capacity usage.

In some embodiments, the processor may be further configured to: update a usage model of the service limit subsystem according to a machine learning model.

In some embodiments, the processor may be further configured to: select a candidate account from a plurality of accounts, wherein the candidate account has a corresponding forecasted account capacity usage that does not exceed a threshold capacity usage for the candidate account.

In some embodiments, the processor may be further configured to: provision an account in the regulated computing environment on a condition that the forecasted account capacity usage exceeds the threshold capacity usage.

In some embodiments, a non-transitory computer readable medium configured to store instructions for managing a state of a provisioned workspace with connectivity to a data resource in a regulated computing environment is disclosed. The instructions, when executed, may cause a processor to perform the following: receiving a request to provision a workspace in the regulated computing environment; determining an account capacity usage across a plurality of cloud computing environments; provisioning the workspace in the regulated computing environment on a condition that a forecasted account capacity usage does not exceed a threshold capacity usage; establishing a connection with a computing resource external to the server system; and saving a state of the workspace using the computing resource external to the server system.

In some embodiments, the instructions, when executed, may cause the processor to further perform the following: requesting a provisioned infrastructure status from an infrastructure configuration data store.

In some embodiments, the instructions, when executed, may cause the processor to further perform the following: updating a usage model of the infrastructure configuration data store according to a machine learning model based on telemetry data received from the cloud computing environments.

In some embodiments, the instructions, when executed, may cause the processor to further perform the following: requesting an account capacity limit from a service limit subsystem; and adjusting the account capacity limit based on the forecasted account capacity usage.

In some embodiments, the instructions, when executed, may cause the processor to further perform the following: updating a usage model of the service limit subsystem according to a machine learning model.

In some embodiments, the instructions, when executed, may cause the processor to further perform the following: selecting a candidate account from a plurality of accounts, wherein the candidate account has a corresponding forecasted account capacity usage that does not exceed a threshold capacity usage for the candidate account.

In some embodiments, the instructions, when executed, may cause the processor to further perform the following: provisioning an account in the regulated computing environment on a condition that the forecasted account capacity usage exceeds the threshold capacity usage.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic workspace management module configured for managing a state of a provisioned workspace with connectivity to a data resource in a regulated computing environment in accordance with an embodiment.

FIG. 2 illustrates a diagram of a network environment with a platform, language, database, and cloud agnostic workspace management device in accordance with an embodiment.

FIG. 3 illustrates a system diagram for implementing a platform, language, database, and cloud agnostic workspace management device having a platform, language, database, and cloud agnostic workspace management module in accordance with an embodiment.

FIG. 4 illustrates a system diagram for implementing a platform, language, database, and cloud agnostic workspace management module of FIG. 3 in accordance with an embodiment.

FIG. 5 illustrates a distributed cloud environment implemented by the workspace management module of FIG. 4 to dynamically update properties across all application instances in accordance with an embodiment.

FIG. 6 illustrates a system diagram illustrating an example multi-cloud quota and capacity management system as implemented by the workspace management module of FIG. 4 in accordance with an embodiment.

FIG. 7 illustrates a system implemented by the workspace management module of FIG. 4 configured for managing a state of a provisioned workspace with connectivity to a data resource in a regulated computing environment in accordance with an embodiment.

FIG. 8 illustrates a flow chart of a process implemented by the platform, language, database, and cloud agnostic workspace management module of FIG. 4 for managing a state of a provisioned workspace with connectivity to a data resource in a regulated computing environment in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

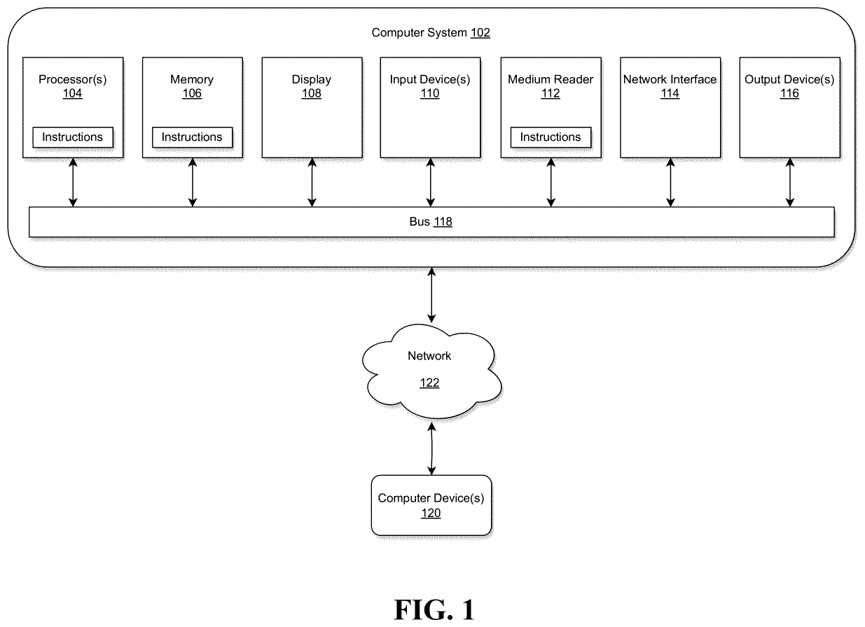

FIG. 1 is a system 100 for use in implementing a platform, language, database, and cloud agnostic workspace management module configured to manage workspaces and workloads at a cross cloud level, move entire workloads and re-provision connections just-in-time through existing deployment control planes, and seamlessly manage connectivity to other vendor products and data resources for MDLC purposes in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the workspace management module implemented by the system 100 may be platform, language, database, and cloud agnostic that may allow for consistent easy orchestration and passing of data through various components to output a desired result regardless of platform, browser, language, database, and cloud environment by writing programs accordingly. Since the disclosed process, in some embodiments, is platform, language, database, browser, and cloud agnostic, the workspace management modulemay be independently tuned or modified for optimal performance without affecting the configuration or data files. The configuration or data files, in some embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in a non-limited embodiment, embodiments may include distributed processing, component/object distributed processing, and an operation mode having parallel processing capabilities. Virtual computer system processing may be constructed to implement one or more of the methods or functionality as described herein, and a processor described herein may be used to support a virtual processing environment.

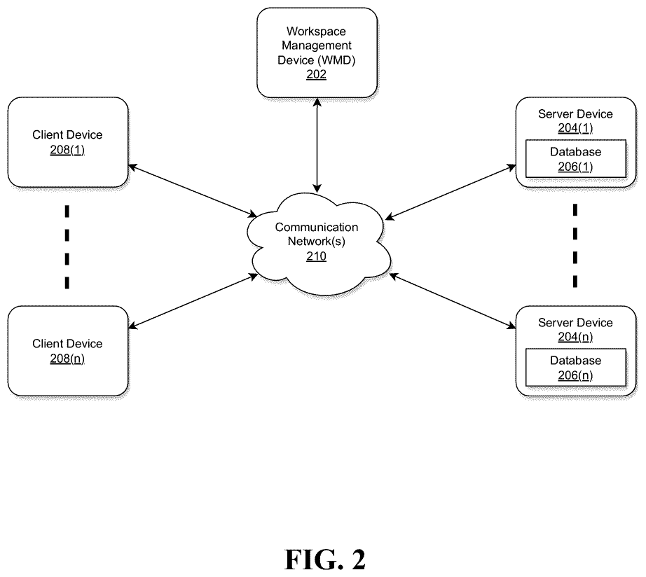

Referring to FIG. 2, a schematic of a network environment 200 for implementing a language, platform, database, and cloud agnostic workspace management device (WMD) of the instant disclosure is illustrated.

In some embodiments, the above-described problems associated with conventional tools may be overcome by implementing a WMD 202 as illustrated in FIG. 2 that may be configured for implementing a platform, language, database, and cloud agnostic workspace management module configured to manage workspaces and workloads at a cross cloud level, move entire workloads and re-provision connections just-in-time through existing deployment control planes, and seamlessly manage connectivity to other vendor products and data resources for MDLC purposes, but the disclosure is not limited thereto.

The WMD 202 may include one or more computer system 102s, as described with respect to FIG. 1, which in aggregate provide the necessary functions.

The WMD 202 may store one or more applications that may include executable instructions that, when executed by the WMD 202, cause the WMD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the WMD 202 itself, may be located in virtual server(s) running in a cloud-based computing environment rather than being tied to one or more specific physical network computing devices. Also, the application(s) may be running in one or more virtual machines (VMs) executing on the WMD 202. Additionally, in one or more embodiments of this technology, virtual machine(s) running on the WMD 202 may be managed or supervised by a hypervisor.

In the network environment 200 of FIG. 2, the WMD 202 may be coupled to a plurality of server devices 204(1)-204(n) that hosts a plurality of databases 206(1)-206(n), and also to a plurality of client devices 208(1)-208(n) via communication network(s) 210. A communication interface of the WMD 202, such as the network interface 114 of the computer system 102 of FIG. 1, operatively couples and communicates between the WMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the WMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The WMD 202 may be a standalone device or integrated with one or more other devices or apparatuses, such as one or more of the server devices 204(1)-204(n), for example. In one particular example, the WMD 202 may be hosted by one of the server devices 204(1)-204(n), and other arrangements are also possible. Moreover, one or more of the devices of the WMD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the WMD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the WMD 202 that may efficiently provide a platform for implementing a platform, language, database, and cloud agnostic workspace management module configured to manage workspaces and workloads at a cross cloud level, move entire workloads and re-provision connections just-in-time through existing deployment control planes, and seamlessly manage connectivity to other vendor products and data resources for MDLC purposes, but the disclosure is not limited thereto.

The client devices 208(1)-208(n) may run interface applications, such as standard web browsers or standalone client applications, which may provide an interface to communicate with the WMD 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the WMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the WMD 202, the server devices 204(1)-204(n), or the client devices 208(1)-208(n), for example, may be configured to operate as virtual instances on the same physical machine. For example, one or more of the WMD 202, the server devices 204(1)-204(n), or the client devices 208(1)-208(n) may operate on the same physical device rather than as separate devices communicating through communication network(s) 210. Additionally, there may be more or fewer WMDs 202, server devices 204(1)-204(n), or client devices 208(1)-208(n) than illustrated in FIG. 2. In some embodiments, the WMD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

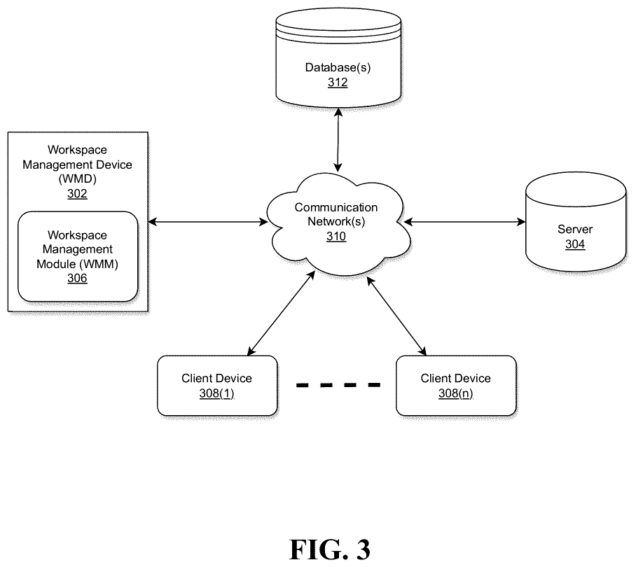

FIG. 3 illustrates a system diagram for implementing a platform, language, and cloud agnostic WMD having a platform, language, database, and cloud agnostic workspace management module (WMM) in accordance with an embodiment.

As illustrated in FIG. 3, the system 300 may include an WMD 302 within which an WMM 306 is embedded, a server 304, a database(s) 312, a plurality of client devices 308(1) . . . 308(n), and a communication network 310.

In some embodiments, the WMD 302 including the WMM 306 may be connected to the server 304, and the database(s) 312 via the communication network 310. The WMD 302 may also be connected to the plurality of client devices 308(1) . . . 308(n) via the communication network 310, but the disclosure is not limited thereto. The database(s) 312 may include one or more rule databases.

In an embodiment, the WMD 302 is described and shown in FIG. 3 as including the WMM 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the WMM 306 may be configured to receive real-time feed of data from the plurality of client devices 308(1) . . . 308(n) and secondary sources via the communication network 310.

The WMM 306 may be configured to: receive a request to provision a workspace in the regulated computing environment; determine an account capacity usage across a plurality of cloud computing environments; provision the workspace in the regulated computing environment on a condition that a forecasted account capacity usage does not exceed a threshold capacity usage; establish a connection with a computing resource external to the server system; and save a state of the workspace using the computing resource external to the server system, but the disclosure is not limited thereto.

The plurality of client devices 308(1) . . . 308(n) are illustrated as being in communication with the WMD 302. In this regard, the plurality of client devices 308(1) . . . 308(n) may be “clients” (e.g., customers) of the WMD 302 and are described herein as such. Nevertheless, it is to be known and understood that the plurality of client devices 308(1) . . . 308(n) need not necessarily be “clients” of the WMD 302, or any entity described in association therewith herein. Any additional or alternative relationship may exist between either or both of the plurality of client devices 308(1) . . . 308(n) and the WMD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the WMD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The WMD 302 may be the same or similar to the WMD 202 as described with respect to FIG. 2, including any features or combination of features described with respect thereto.

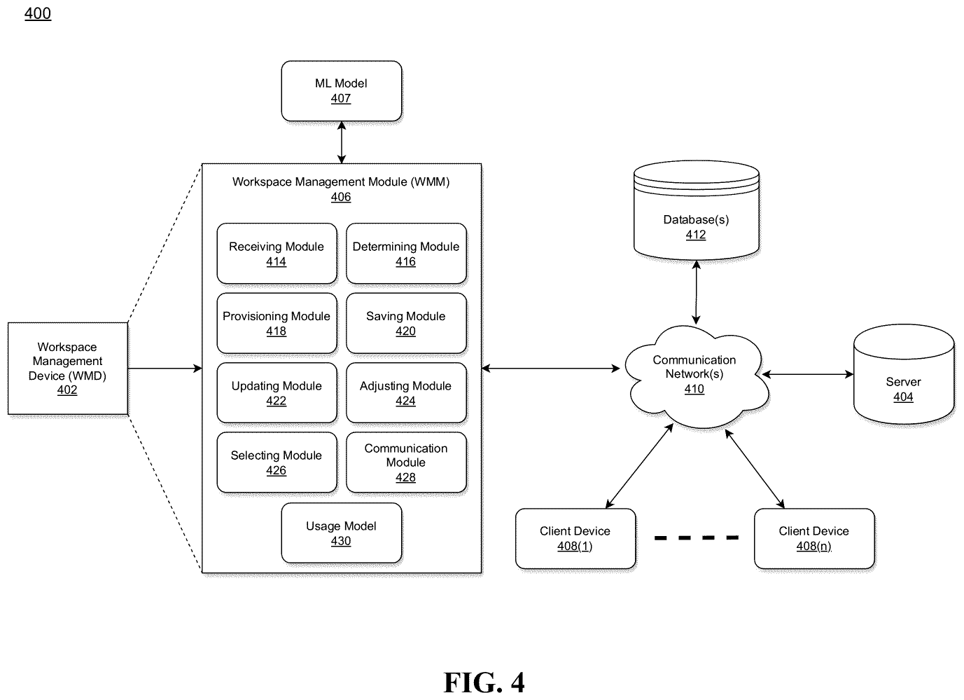

FIG. 4 illustrates a system diagram for implementing a platform, language, database, and cloud agnostic WMM of FIG. 3 in accordance with an embodiment.

In some embodiments, the system 400 may include a platform, language, database, and cloud agnostic WMD 402 within which a platform, language, database, and cloud agnostic WMM 406 is embedded, a server 404, database(s) 412, and a communication network 410. In some embodiments, server 404 may comprise a plurality of servers located centrally or located in different locations, but the disclosure is not limited thereto.

In some embodiments, the WMD 402 including the WMM 406 may be connected to the server 404, an AI/ML model 407, and the database(s) 412 via the communication network 410. The WMD 402 may also be connected to the plurality of client devices 408(1)-408(n) via the communication network 410, but the disclosure is not limited thereto. The WMM 406, the server 404, the plurality of client devices 408(1)-408(n), the database(s) 412, the communication network 410 as illustrated in FIG. 4 may be the same or similar to the WMM 306, the server 304, the plurality of client devices 308(1)-308(n), the database(s) 312, the communication network 310, respectively, as illustrated in FIG. 3.

Details of the WMM 406 is provided below with corresponding modules that may be configured to, in combination, to manage workspaces and workloads at a cross cloud level, move entire workloads and re-provision connections just-in-time through existing deployment control planes, and seamlessly manage connectivity to other vendor products and data resources for MDLC purposes, but the disclosure is not limited thereto.

In some embodiments, the WMM 406 as disclosed herein may be utilized to create a bounded environment (termed as a workspace) where users may perform AI/ML related activities including experimentation (data and model), freely while controls are maintained at the boundary. As part of the platform capability, the WMM 406 may be configured to save the state of a workspace where the users perform various AI/ML activities and store the state of the workspace associated with a model development for reproducibility and authoritative model building pipelines and as evidence for Model governance purposes, but the disclosure is not limited thereto.

In some embodiments, as part of the state storage, the WMM 406 may be configured to capture the connectivity required to data products and data stores (data resources) to the workspace and vendor products and model frameworks while ensuring segregation and maintaining access control. Moreover, the WMM 406 may be configured to reproduce these connections when the workspace migrates and provide least privilege orchestration to enable these connectivity only at time of workload launch and shutdowns after workload finishes and the membership of users to the workspaces, but the disclosure is not limited thereto.

In some embodiments, the WMM 406 may be configured to store the state of workspaces to support the capability to migrate the workspaces and scale them for the workloads between cloud accounts due to limits and shared capacity usage in an automated manner.

In some embodiments, the WMM 406 may be configured to hibernate a workspace during non-usage period and restart the workloads automatically during working periods.

In some embodiments, as illustrated in FIG. 4, the WMM 406 may include a receiving module 414, a determining module 416, a provisioning module 418, a saving module 420, an updating module 422, an adjusting module 424, a selecting module 426, a communication module 428, and a usage model 430. In some embodiments, interactions and data exchange among these modules included in the WMM 406 provide the advantageous effects of the disclosed invention. Functionalities of each module of FIG. 4 may be described in detail below with reference to FIGS. 4-8.

In some embodiments, each of the receiving module 414, determining module 416, provisioning module 418, saving module 420, updating module 422, adjusting module 424, selecting module 426, and the communication module 428 of the WMM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, determining module 416, provisioning module 418, saving module 420, updating module 422, adjusting module 424, selecting module 426, and the communication module 428 of the WMM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, determining module 416, provisioning module 418, saving module 420, updating module 422, adjusting module 424, selecting module 426, and the communication module 428 of the WMM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the WMM 406 of FIG. 4 may also be implemented by cloud based deployment.

In some embodiments, each of the receiving module 414, determining module 416, provisioning module 418, saving module 420, updating module 422, adjusting module 424, selecting module 426, and the communication module 428 of the WMM 406 of FIG. 4 may be called via corresponding API, but the disclosure is not limited thereto.

In some embodiments, the process implemented by the WMM 406 may be executed via the communication module 428 and the communication network 410, which may comprise plural networks as described above. For example, in an embodiment, the various components of the WMM 406 may communicate with the server 404, and the database(s) 412 via the communication module 428 and the communication network 410 and the results may be displayed onto a graphical user interface. Of course, these embodiments are merely exemplary and are not limiting or exhaustive. The database(s) 412 may include the databases included within the private cloud and/or public cloud and the server 404 may include one or more servers within the private cloud and the public cloud.

For example, enterprise users often create workspaces for use within a distributed cloud environment. A workspace may be a logical entity with multiple physical placements of workloads. The workspace may provide productivity/collaborative tools, etc. and facilitate the completion of work by enterprise users. However, such cloud computing workspaces may prove to be difficult to manage. An enterprise user may have a workspace on a computing platform such as AWS™ for example and another workspace on a different cloud computing platform such as Azure™. Both platforms may be subject to different parameters and constraints (e.g., capacity constraints). On existing platforms, the enterprise user is unable to associate both workspaces to address capacity thresholds (for example) defined by the different cloud computing platforms.

Moreover, some computing environments are highly regulated. A regulated computing environment may be one that may be subject to regulatory compliance or standards, such as regulations relating to unauthorized access, data privacy and protection of personal identifiable information and the like. Here, the regulations require that AI/ML activities be tracked for model governance purposes. On existing computing platforms, the enterprise user is unable to track the user's AI/ML activities particularly across computing platforms environments and infrastructure per model version development for model governance.

The present disclosure addresses the foregoing by providing a method, system, and computer program product for managing a state of a provisioned workspace with connectivity to a data resource in a regulated computing environment by implementing the WMM 406. The method receives a request to provision a workspace in the regulated computing environment. The provisioning request may emanate from a user interface API, for example.

The method includes determining an account capacity usage across a plurality of cloud computing environments. In one implementation, the first cloud computing platform may be AWS™ for example while the second cloud computing platform is Azure™ for example. The method provisions the workspace in the regulated computing environment on a condition that a forecasted account capacity usage does not exceed a threshold capacity usage. In other words, the method correlates the determined account capacity usage to a threshold capacity usage before provisioning the workspace.

The method may further include establishing a connection with a computing resource external to the server system. In one implementation, the establishment of a connection with an external server system (i.e., server 404) may be via an external resource connector. The method may include saving a state of the workspace using the computing resource external to the server system. By saving the state of the workspace, an audit trail may be maintained for model governance purposes.

More specifically, in some embodiments, an orchestrator and state store system may generate and provide evidence via an audit trail for workspace management, e.g., for AI and/or ML workloads. The orchestrator and state store system may provide one or more of workspace provisioning and migration management, an external resource connector, workspace service management, workspace operational functions for cost operations, and/or workspace membership management.

Various embodiments implemented by the WMM 406 may provide the ability to manage workspaces at a multi-cloud level and provide regulatory information that may be used for a model training environment, auditing, and automated connectivity of data resources to workspaces in a seamless manner. Embodiments of the present disclosure may move entire workloads and re-provision connections on a just-in-time basis through existing deployment control planes.

Some embodiments capture the connectivity that is to be established between the workspace and data products and data stores (e.g., data resources) and vendor products and model frameworks while ensuring segregation, e.g., between workspaces corresponding to different users. In some embodiments, connections are reproducible when the workspace migrates. Least privilege orchestration may be provided to enable connectivity (e.g., only) at workload launch. When a workload finishes, the user's Principals (IAM Roles/Azure role assignments etc.,) may be disabled.

In some embodiments, the state of a workspace may be stored to support the capability to migrate workspaces and to scale them for the workload between cloud accounts due to limits and shared capacity usage. In some embodiments, a workspace may be hibernated during periods of non-usage to conserve operational resources and reduce costs. During periods of usage, a workload may automatically be restarted.

Referring back to FIG. 4, the receiving module 414 may be configured to receive a request to provision a workspace in the regulated computing environment. The determining module 416 may be configured to determine an account capacity usage across a plurality of cloud computing environments.

The determining module 416 may be configured to determine an account capacity usage across a plurality of cloud computing environments.

In some embodiments, the account capacity may be tracked, and regression model may be applied for time series forecasting to estimate the elasticity of capacity usage within the context of a workspace (WS) (i.e., used capacity or available capacity) over a period of time, but the disclosure is not limited thereto. The ‘algorithm’/sequence of steps may include the following processes.

In some embodiments, the algorithm may be run as a loop over a user defined ‘placement group’ that may be defined as a group of plurality of cloud environments that may host a workspace.

For used capacity over a period of time, the WMM 406 may utilize the data that is being collected (metrics of usage). Additionally, another model may be utilized the context of the workspace's intent to classify the existing workspace's intent, i.e., WS classifier model, but the disclosure is not limited thereto. For example, the implementation choice of exact ML algorithm or model may change depending on user's desire and stage of development process.

The available capacity and limits may be usually published by the cloud provider, and the WMM 406 may consume them from their APIs and store it in an accounts limits manager. These may be utilized for the capacity limits calculation. The account capacity tracker may be utilized to retrieve the provisioned (near real time) information about the account capacity.

The WMM 406 may then utilize an account capacity usage forecasting service with a machine learning model 407, i.e., WS Usage Forecaster Model, that may forecast the capacity usage of a workspace in any cloud account automatically, but the disclosure is not limited thereto. For example, the implementation choice of exact ML algorithm may change as depending on user's desire and stage of development process.

Additionally, the WMM 406 may also aim to group and predict the usage of capacity at a workspace level through classification. For example, the WMM 406 may monitor and enable auto re-train to ensure tracking and considering any drift of usage metrics over time. The output of the model may provide the forecasted use of any particular account inside a placement group, and stored in a database 412.

The provisioning module 418 may be configured to provision the workspace in the regulated computing environment on a condition that a forecasted account capacity usage does not exceed a threshold capacity usage.

For example, the WMM 406 may implement a ‘round robin method’ based on ‘S/M/L’ usage sizing heuristically—but may also implement an automated method using the ML model 407 as desired.

An exemplary ‘round robin method” may include the following processing, but the disclosure is not limited thereto.

In step 1, the previous ML model output may run over the placement group, that is stored in a database 412 may be read and a placement decision may be made by comparison of the expected use of a workspace of similar classification to the available capacity in a cloud account.

In step 2, if it's a new workspace, a WS classifier model may be run to identify the intent, and this may be fed into a WS usage forecaster model to identify the potential forecasted usage and then may be placed therein.

In step 3, once provisioned, the state of provisioning and capacity usage may be constantly monitored at a user defined time interval (i.e., one hour, but the disclosure is not limited thereto). Workspace placements may be migrated to different accounts in the ‘placement group’ proactively if a forecasted usage changes. In some embodiments, migration may be achieved by using the state and configuration details that are part of the core workspace management module service.

The communication module 428 may be configured to establish a connection with a computing resource external to the server system. The saving module 420 may be configured to save a state of the workspace using the computing resource external to the server system.

In some embodiments, the WMM 406 may be configured to request a provisioned infrastructure status from an infrastructure configuration data store.

In some embodiments, the updating module 422 may be configured to update a usage model 430 of the infrastructure configuration data store according to a machine learning model (i.e., ML model 407) based on telemetry data received from the cloud computing environments.

In some embodiments, the WMM 406 may be configured to request an account capacity limit from a service limit subsystem; and the adjusting module 424 may be configured to adjust the account capacity limit based on the forecasted account capacity usage.

In some embodiments, the updating module 422 may be further configured to update a usage model 430 of the service limit subsystem according to a machine learning model (i.e., ML model 407).

In some embodiments, the selecting module 426 may be configured to select a candidate account from a plurality of accounts. The candidate account may include a corresponding forecasted account capacity usage that does not exceed a threshold capacity usage for the candidate account.

In some embodiments, the provisioning module 418 may be configured to provision an account in the regulated computing environment on a condition that the forecasted account capacity usage exceeds the threshold capacity usage.

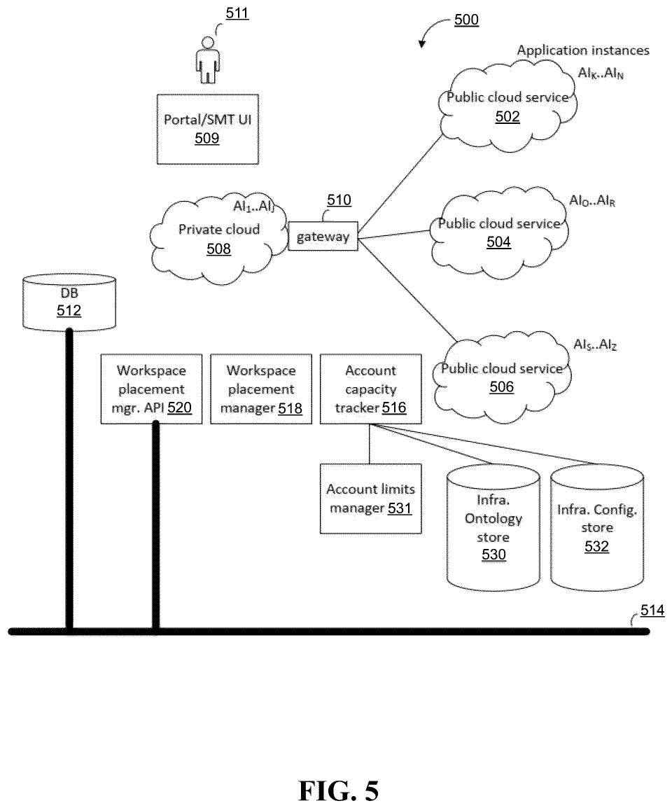

FIG. 5 illustrates a distributed cloud environment 500 implemented by the WMM 406 of FIG. 4 to dynamically update properties across all application instances in accordance with an embodiment. FIG. 5 illustrates a distributed cloud environment 500 for managing a state of a provisioned workspace with connectivity to a data resource in a regulated computing environment, according to examples of the present disclosure. In the example of FIG. 5, distributed cloud environment 500 includes three public cloud services 502, 504, 506 that are communicably coupled to a private cloud 508 via a gateway 510. Although not shown, distributed cloud environment 500 may include additional or fewer public and private clouds, and the arrangement and components of such a distributed cloud environment may vary.

In FIG. 5, private cloud 508 may be a corporate enterprise data network secured by a firewall (not shown). This secure private cloud may be coupled via gateway 510 to the public cloud services 502, 504, 506. Public cloud services 502, 504, 506 may be from any one or more public cloud service providers such as Amazon AWS, Microsoft Azure, Google Cloud, etc.

Irrespective of the cloud service type, each cloud service may be dynamically scalable and may facilitate the execution of multiple instances of any application. Here, private cloud 508 may run an application with multiple instances AI1 through AIJ. Similarly, public cloud service 502 may have multiple instances AIK through AIN of the same application. Public cloud service 506 may have multiple application instances AIP through AIZ. The application instances may vary depending upon demand. For example, the cloud platform may include an autoscaling feature (not shown) that may increase or decrease capacity as necessitated by demand.

When demand increases, additional instances may be automatically launched and provisioned. When demand reduces, instances may be automatically deregistered and decommissioned commensurate with the reduced demand. In some embodiments, it is desirable to capture the connectivity that is to be established between the workspace and data products and data stores (e.g., data resources) and vendor products and model frameworks while ensuring segregation, e.g., between workspaces corresponding to different users. In some embodiments, connections may be reproducible when the workspace migrates. Least privilege orchestration may be provided to enable connectivity (e.g., only) at workload launch. When a workload finishes, connectivity may be disabled. Membership of users to workspaces may be disabled or removed when a workload is finished. In some embodiments, the state of a workspace may be stored to support the capability to migrate workspaces and to scale them for the workload between cloud accounts due to limits and shared capacity usage. In some embodiments, a workspace may be hibernated during periods of non-usage to conserve operational resources and reduce costs. During periods of usage, a workload may automatically be restarted.

In FIG. 5, distributed cloud environment 500 further includes a portal/server management tool (SMT) user interface (UI) 509, a database 512, and a workspace placement bus 514 interface. Portal/SMT UI 509 may be employed by a system administrator 501 to access and manage the distributed cloud environment 500. For example, such management may include use of an SMT to manage applications, monitor server performance, and/or manually provision and decommission instances.

As shown in FIG. 5, database 512 may be any database to store application property values. An application property value is a value of an environment-specific variable that may enable, disable, or limit a specific functionality such as an arbitrary decision inside the application. As an example, an application property value may be employed to set a timeout. As another example, an application property value may be to pass a list of users through the application. The database 512 may be implemented in, for example, Cassandra™. In another example, the database 512 may be a NoSQL database although other database types may be employed. The database 512 may have a distributed architecture that spans multiple clusters. Thus, although not shown, database 512 may be deployed across a large number of nodes spanning private cloud 508 and public cloud services 502, 504, 506. As shown, in one example, database 512 is to interface with the workspace placement bus 514. The workspace placement bus 514 is an interface to which any database, data storage device, or other real-time data stream may be connected. In other words, workspace placement bus 514 provides interaction with an arbitrary data store.

In some embodiments, the distributed cloud environment 500 may include an account capacity tracker 516, a workspace placement manager 518, and a workspace placement manager API (Application Programming Interface) 520. As shown, the workspace placement manager API 520 may interface with the dynamic property bus 514. Workspace placement manager API 520 may be or may include a module, program, or software instructions to receive/respond to calls and facilitate data exchange between the http client (e.g., on portal/SMT UI 509) and the workspace placement manager 518/database 512.

In the example shown in FIG. 5, the workspace placement manager 518 may be implemented as a module, software, or program. In some embodiments, the workspace placement manager 518 is to issue a request to provision a workspace in the regulated computing environment. The account capacity tracker 516 may receive the request to provision the workspace and may determine an account capacity usage across a plurality of cloud computing environments, e.g., the public cloud services 502, 504,506. Account capacity usage may refer to an amount of computing resources that are being used by an account, e.g., relative to a threshold amount of computing resources, such as a soft limit or a hard limit. A soft limit may be adjustable, for example, in response to high demand, while a hard limit may be fixed.

In some embodiments, the workspace placement manager 518 may receive instructions from workspace placement manager API 520 to provision the workspace in the regulated computing environment on a condition that a forecasted account capacity usage does not exceed a threshold capacity. The account capacity tracker 516 may forecast an account capacity usage for an account, for example, based on data sourced from one or more data stores, including, e.g., an infrastructure ontology store 530 and/or an infrastructure configuration store 532. These data stores may obtain telemetry data from one or more events and/or workload accounts. Telemetry data may include, for example, real-time and/or historical traffic information.

In some embodiments, the account capacity tracker 516 may send a request to an account limits manager 532, for example, if the forecasted account capacity usage exceeds the threshold capacity. The threshold capacity may represent a soft limit on capacity usage. If the account capacity tracker 516 determines that the forecasted account capacity usage is likely to exceed the threshold capacity, the account capacity tracker 516 may request an increase in the threshold capacity. The account limits manager 532 may determine whether to increase the threshold capacity for an account based on one or more factors, including, for example, a comparison between the threshold capacity and a soft limit and/or a hard limit, existing or potential requests for additional capacity increases for other accounts, and the like.

In some embodiments, the workspace placement manager 518 may establish a connection with a computing resource external to the server system. For example, the workspace placement manager 518 may use the gateway 510 to establish a connection with a computer or mobile device that is connected to one or more of public cloud services 502, 504, 506.

In some embodiments, the workplace placement manager 518 may save a state of a workspace using the computing resource that is external to the server system. For example, when migrating a workspace from a first location to a second location, the workplace placement manager 518 may save the state of the workspace before migrating the workspace to the second location. The workplace placement manager 518 may use a computing resource that is connected to one or more of public cloud services 502, 504, 506.

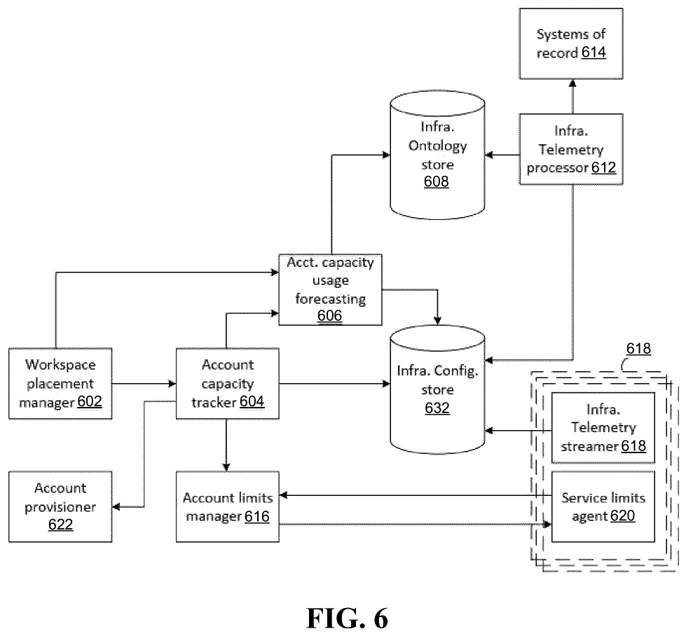

FIG. 6 illustrates a system diagram illustrating an example multi-cloud quota and capacity management system 600 as implemented by the WMM 406 of FIG. 4 in accordance with an embodiment.

In some embodiments, a workspace placement manager 602 may issue a request to provision a workspace in a regulated computing environment. An account capacity tracker 604 may receive the request to provision the workspace and may determine an account capacity usage across a plurality of cloud computing environments. For example, the account capacity tracker 604 may receive forecast data from an account capacity usage forecaster 606 to determine probable capacity usage based on metrics. In some embodiments, the account capacity usage forecaster 606 forecasts capacity usage for an account based on data sourced from one or more data stores, including, e.g., an infrastructure ontology store 608 and/or an infrastructure configuration store 632. These data stores may obtain telemetry data from one or more events and/or workload accounts. Telemetry data may include, for example, real-time and/or historical traffic information obtained from an infrastructure telemetry processor 612. The infrastructure telemetry processor 612 may populate the infrastructure ontology store 608 and/or may provide metrics and contextual information to the infrastructure configuration store 632. In some embodiments, the infrastructure telemetry processor 612 receives contextual information from one or more systems of record 614 in the multi-cloud quota and capacity management system 600.

In some embodiments, the infrastructure configuration store 632 may receive event-based streams from one or more infrastructure telemetry streamers 616 associated with one or more workload accounts 618.

In some embodiments, the account limits manager 608 may receive a request from the account capacity tracker 604 for an increase in an account capacity, for example, if the forecasted account capacity usage exceeds the threshold capacity. The threshold capacity may represent a soft limit on capacity usage. The account limits manager 608 may determine whether to increase the threshold capacity for an account based on one or more factors, including, for example, a comparison between the threshold capacity and a soft limit and/or a hard limit, existing or potential requests for additional capacity increases for other accounts, and the like. In some embodiments, the account limits manager 608 may receive event-based streams from one or more service limits agents 620 associated with the one or more workload accounts 618.

In some embodiments, if the account capacity tracker 604 determines that a new account is needed to service the request for additional capacity, the account capacity tracker 604 may send a request to an account provisioner 622. The account capacity tracker 604 may identify one or more accounts that has available capacity and may send a request to the account provisioner 622 to provision one or more accounts with available capacity so that the available capacity is available for use.

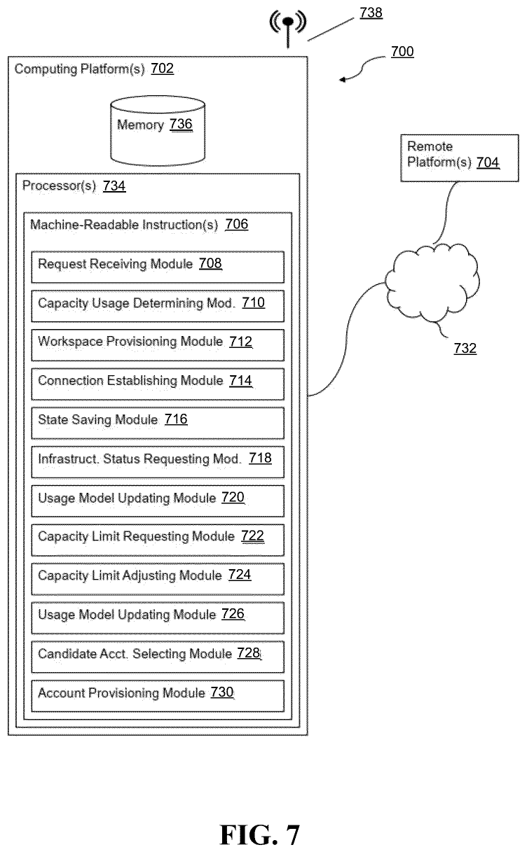

FIG. 7 illustrates a system 700 implemented by the WMM 406 of FIG. 4 configured for managing a state of a provisioned workspace with connectivity to a data resource in a regulated computing environment in accordance with an embodiment.

In some cases, system 700 may include one or more computing platforms 702. The one or more remote computing platforms 702 may be communicably coupled with one or more remote platforms 704. In some cases, users may access the system 700 via remote platform(s) 704.

The one or more computing platforms 702 may be configured by machine-readable instructions 706. Machine-readable instructions 706 may include modules. The modules may be implemented as one or more of functional logic, hardware logic, electronic circuitry, software modules, and the like. The modules may include one or more of request receiving module 708, capacity usage determining module 710, workspace provisioning module 712, connection establishing module 714, state saving module 716, infrastructure status requesting module 718, usage model updating module 720, capacity limit requesting module 722, capacity limit adjusting module 724, usage model updating module 726, candidate account selecting module 728, account provisioning module 730, and/or other modules.

Request receiving module 708 may be configured to receive a request to provision a workspace in the regulated computing environment. Capacity usage determining module 710 may be configured to determine an account capacity usage across a plurality of cloud computing environments. Workspace provisioning module 712 may be configured to provision the workspace in the regulated computing environment on a condition that a forecasted account capacity usage does not exceed a threshold capacity usage. Connection establishing module 714 may be configured to establish a connection with a computing resource external to the server system. State saving module 716 may be configured to save a state of the workspace using the computing resource external to the server system.

Infrastructure status requesting module 718 may be configured to request a provisioned infrastructure status from an infrastructure configuration data store.

Usage model updating module 720 may be configured to update a usage model of the infrastructure configuration data store according to a machine learning model based on telemetry data received from the cloud computing environments. In some cases, the telemetry data may be aggregated according to rules received from an aggregation rule data store and the aggregated telemetry data includes at least one of a source identifier and context information.

Capacity limit requesting module 722 may be configured to request an account capacity limit from a service limit subsystem. Capacity limit adjusting module 724 may be configured to adjust the account capacity limit based on the forecasted account capacity usage.

Usage model updating module 726 may be configured to update a usage model of the service limit subsystem according to a machine learning model.

Candidate account selecting module 728 may be configured to select a candidate account from a plurality of accounts.

Account provisioning module 730 may be configured to provision an account in the regulated computing environment on a condition that the forecasted account capacity usage exceeds the threshold capacity usage.

In some cases, the one or more computing platforms 702, may be communicatively coupled to the remote platform(s) 704. In some cases, the communicative coupling may include communicative coupling through a networked environment 732. The networked environment 732 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes embodiments in which one or more computing platforms 702 and remote platform(s) 704 may be operatively linked via some other communication coupling. The one or more one or more computing platforms 702 may be configured to communicate with the networked environment 732 via wireless or wired connections. In addition, in an embodiment, the one or more computing platforms 702 may be configured to communicate directly with each other via wireless or wired connections. Examples of one or more computing platforms 702 may include, but is not limited to, smartphones, wearable devices, tablets, laptop computers, desktop computers, Internet of Things (IoT) device, or other mobile or stationary devices. In an embodiment, system 700 may also include one or more hosts or servers, such as the one or more remote platforms 704 connected to the networked environment 732 through wireless or wired connections. According to one embodiment, remote platforms 704 may be implemented in or function as base stations (which may also be referred to as Node Bs or evolved Node Bs (eNBs)). In other embodiments, remote platforms 704 may include web servers, mail servers, application servers, etc. According to certain embodiments, remote platforms 704 may be standalone servers, networked servers, or an array of servers.

The one or more computing platforms 702 may include one or more processors 734 for processing information and executing instructions or operations. One or more processors 734 may be any type of general or specific purpose processor. In some cases, multiple processors 734 may be utilized according to other embodiments. In fact, the one or more processors 734 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 734 may be remote from the one or more computing platforms 702, such as disposed within a remote platform like the one or more remote platforms 734 of FIG. 7.

The one or more processors 734 may perform functions associated with the operation of system 700 which may include, for example, precoding of antenna gain/phase parameters, encoding and decoding of individual bits forming a communication message, formatting of information, and overall control of the one or more computing platforms 702, including processes related to management of communication resources.

The one or more computing platforms 702 may further include or be coupled to a memory 736 (internal or external), which may be coupled to one or more processors 734, for storing information and instructions that may be executed by one or more processors 734. Memory 736 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, memory 736 may consist of any combination of random access memory (RAM), read only memory (ROM), static storage such as a magnetic or optical disk, hard disk drive (HDD), or any other type of non-transitory machine or computer readable media. The instructions stored in memory 736 may include program instructions or computer program code that, when executed by one or more processors 734, enable the one or more computing platforms 702 to perform tasks as described herein.

In some embodiments, one or more computing platforms 702 may also include or be coupled to one or more antennas 738 for transmitting and receiving signals and/or data to and from one or more computing platforms 702. The one or more antennas 738 may be configured to communicate via, for example, a plurality of radio interfaces that may be coupled to the one or more antennas 738. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

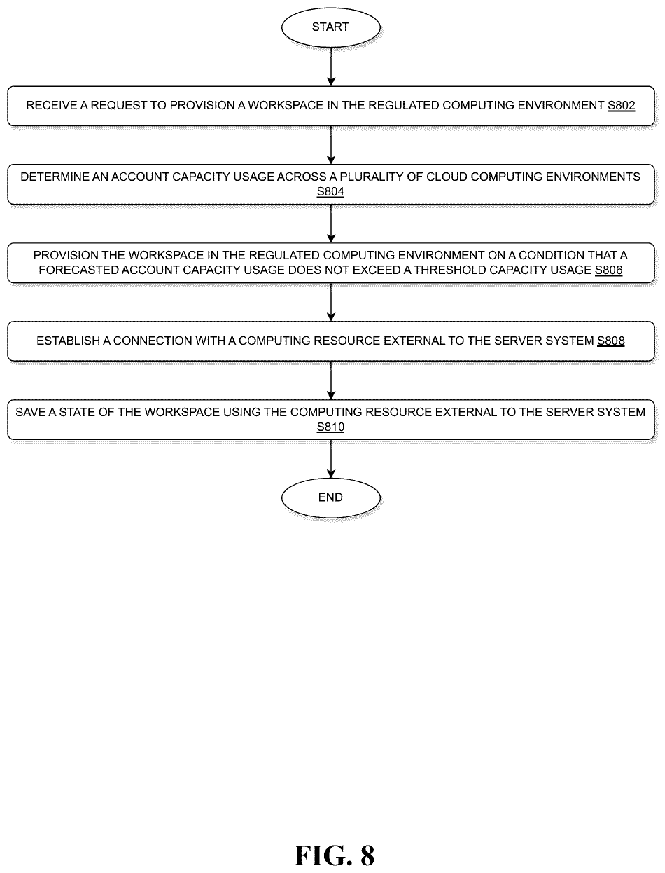

FIG. 8 illustrates a flow chart of a process 800 implemented by the platform, language, database, and cloud agnostic WMM 406 of FIG. 4 for managing a state of a provisioned workspace with connectivity to a data resource in a regulated computing environment in accordance with an embodiment.

For example, FIG. 8 illustrates a flow chart of a process 800 implemented by the WMM 406 of FIG. 4 for enablement of consistent access enforcement across data platforms triggered by an authoritative and active data catalog in accordance with an embodiment. It may be appreciated that the illustrated process 800 and associated steps may be performed in a different order, with illustrated steps omitted, with additional steps added, or with a combination of reordered, combined, omitted, or additional steps.

As illustrated in FIG. 8, at step S802, the process 800 may include receiving a request to provision a workspace in the regulated computing environment.

At step S804, the process 800 may include determining an account capacity usage across a plurality of cloud computing environments.

At step S806, the process 800 may include provisioning the workspace in the regulated computing environment on a condition that a forecasted account capacity usage does not exceed a threshold capacity usage.

At step S808, the process 800 may include establishing a connection with a computing resource external to the server system.

At step S810, the process 800 may include saving a state of the workspace using the computing resource external to the server system.

In some embodiments, the process 800 may further include: requesting a provisioned infrastructure status from an infrastructure configuration data store.

In some embodiments, the process 800 may further include: updating a usage model of the infrastructure configuration data store according to a machine learning model based on telemetry data received from the cloud computing environments.

In some embodiments, the telemetry data may be aggregated according to rules received from an aggregation rule data store.

In some embodiments, the aggregated telemetry data may include at least one of a source identifier and context information.

In some embodiments, the process 800 may further include: requesting an account capacity limit from a service limit subsystem; and adjusting the account capacity limit based on the forecasted account capacity usage.

In some embodiments, the process 800 may further include: updating a usage model of the service limit subsystem according to a machine learning model.

In some embodiments, the process 800 may further include: selecting a candidate account from a plurality of accounts, wherein the candidate account has a corresponding forecasted account capacity usage that does not exceed a threshold capacity usage for the candidate account.

In some embodiments, the process 800 may further include: provisioning an account in the regulated computing environment on a condition that the forecasted account capacity usage exceeds the threshold capacity usage.

In some embodiments, the WMD 402 may include a memory (e.g., a memory 106 as illustrated in FIG. 1) which may be a non-transitory computer readable medium that may be configured to store instructions for implementing a platform, language, database, and cloud agnostic WMM 406 for managing a state of a provisioned workspace with connectivity to a data resource in a regulated computing environment as disclosed herein. The WMD 402 may also include a medium reader (e.g., a medium reader 112 as illustrated in FIG. 1) which may be configured to read any one or more sets of instructions, e.g., software, from any of the memories described herein. The instructions, when executed by a processor embedded within the WMM 406 or within the WMD 402, may be used to perform one or more of the methods and processes as described herein. In a particular embodiment, the instructions may reside completely, or at least partially, within the memory 106, the medium reader 112, and/or the processor 104 (see FIG. 1) during execution by the WMD 402.

In some embodiments, the instructions, when executed, may cause a processor embedded within the WMM 406 or the WMD 402 to perform the following: receiving a request to provision a workspace in the regulated computing environment; determining an account capacity usage across a plurality of cloud computing environments; provisioning the workspace in the regulated computing environment on a condition that a forecasted account capacity usage does not exceed a threshold capacity usage; establishing a connection with a computing resource external to the server system; and saving a state of the workspace using the computing resource external to the server system, but the disclosure is not limited thereto. In some embodiments, the processor may be the same or similar to the processor 104 as illustrated in FIG. 1 or the processor embedded within the WMD 202, WMD 302, WMD 402, and WMM 406 which is the same or similar to the processor 104.

In some embodiments, the instructions, when executed, may cause the processor 104 to further perform the following: requesting a provisioned infrastructure status from an infrastructure configuration data store.

In some embodiments, the instructions, when executed, may cause the processor 104 to further perform the following: updating a usage model of the infrastructure configuration data store according to a machine learning model based on telemetry data received from the cloud computing environments.

In some embodiments, the instructions, when executed, may cause the processor 104 to further perform the following: requesting an account capacity limit from a service limit subsystem; and adjusting the account capacity limit based on the forecasted account capacity usage.

In some embodiments, the instructions, when executed, may cause the processor 104 to further perform the following: updating a usage model of the service limit subsystem according to a machine learning model.

In some embodiments, the instructions, when executed, may cause the processor 104 to further perform the following: selecting a candidate account from a plurality of accounts, wherein the candidate account has a corresponding forecasted account capacity usage that does not exceed a threshold capacity usage for the candidate account.

In some embodiments, the instructions, when executed, may cause the processor 104 to further perform the following: provisioning an account in the regulated computing environment on a condition that the forecasted account capacity usage exceeds the threshold capacity usage.

In some embodiments as disclosed above in FIGS. 1-8, technical improvements effected by the instant disclosure may include a platform for implementing a platform, language, database, and cloud agnostic workspace management module configured for managing workspaces and workloads at a cross cloud level, move entire workloads and re-provision connections just-in-time through existing deployment control planes, and seamlessly manage connectivity to other vendor products and data resources for MDLC purposes, but the disclosure is not limited thereto. Therefore, users may instantly gain insight into hallucination probability and revise a query accordingly.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware embodiments, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware embodiments, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for managing a state of a provisioned workspace with connectivity to a data resource in a regulated computing environment by utilizing one or more processors along with allocated memory, the method comprising:
receiving a request to provision a workspace in the regulated computing environment;
determining an account capacity usage across a plurality of cloud computing environments;
provisioning the workspace in the regulated computing environment on a condition that a forecasted account capacity usage does not exceed a threshold capacity usage;
establishing a connection with a computing resource external to the server system; and
saving a state of the workspace using the computing resource external to the server system.

2. The method according to claim 1, further comprising:
requesting a provisioned infrastructure status from an infrastructure configuration data store.

3. The method according to claim 2, further comprising:
updating a usage model of the infrastructure configuration data store according to a machine learning model based on telemetry data received from the cloud computing environments.

4. The method according to claim 3, wherein the telemetry data is aggregated according to rules received from an aggregation rule data store.

5. The method according to claim 4, wherein the aggregated telemetry data includes at least one of a source identifier and context information.

6. The method according to claim 1, further comprising:
requesting an account capacity limit from a service limit subsystem; and
adjusting the account capacity limit based on the forecasted account capacity usage.

7. The method according to claim 6, further comprising:
updating a usage model of the service limit subsystem according to a machine learning model.

8. The method according to claim 1, further comprising:
selecting a candidate account from a plurality of accounts, wherein the candidate account has a corresponding forecasted account capacity usage that does not exceed a threshold capacity usage for the candidate account.

9. The method according to claim 1, further comprising:
provisioning an account in the regulated computing environment on a condition that the forecasted account capacity usage exceeds the threshold capacity usage.

10. A system for managing a state of a provisioned workspace with connectivity to a data resource in a regulated computing environment, the system comprising:
a processor; and
a memory operatively connected to the processor via a communication interface, the memory storing computer readable instructions, when executed, causes the processor to:
receive a request to provision a workspace in the regulated computing environment;
determine an account capacity usage across a plurality of cloud computing environments;
provision the workspace in the regulated computing environment on a condition that a forecasted account capacity usage does not exceed a threshold capacity usage;
establish a connection with a computing resource external to the server system; and
save a state of the workspace using the computing resource external to the server system.

11. The system according to claim 10, wherein the processor is further configured to:
request a provisioned infrastructure status from an infrastructure configuration data store.

12. The system according to claim 11, wherein the processor is further configured to:
update a usage model of the infrastructure configuration data store according to a machine learning model based on telemetry data received from the cloud computing environments.

13. The system according to claim 12, wherein the telemetry data is aggregated according to rules received from an aggregation rule data store.

14. The system according to claim 13, wherein the aggregated telemetry data includes at least one of a source identifier and context information.

15. The system according to claim 10, wherein the processor is further configured to:
request an account capacity limit from a service limit subsystem; and
adjust the account capacity limit based on the forecasted account capacity usage.

16. The system according to claim 15, wherein the processor is further configured to:
update a usage model of the service limit subsystem according to a machine learning model.

17. The system according to claim 10, wherein the processor is further configured to:
select a candidate account from a plurality of accounts, wherein the candidate account has a corresponding forecasted account capacity usage that does not exceed a threshold capacity usage for the candidate account.

18. The system according to claim 10, wherein the processor is further configured to:
provision an account in the regulated computing environment on a condition that the forecasted account capacity usage exceeds the threshold capacity usage.

19. A non-transitory computer readable medium configured to store instructions for managing a state of a provisioned workspace with connectivity to a data resource in a regulated computing environment, the instructions, when executed, cause a processor to perform the following:
receiving a request to provision a workspace in the regulated computing environment;
determining an account capacity usage across a plurality of cloud computing environments;
provisioning the workspace in the regulated computing environment on a condition that a forecasted account capacity usage does not exceed a threshold capacity usage;
establishing a connection with a computing resource external to the server system; and
saving a state of the workspace using the computing resource external to the server system.

20. The non-transitory computer readable medium according to claim 19, the instructions, when executed, cause the processor to further perform the following:
requesting a provisioned infrastructure status from an infrastructure configuration data store.
